(19) United States
(12) Patent Application Publication
(10) Pub. No.: US 2026/0369298 A1
(43) Pub. Date: Nov. 19, 2026

(54) TURNTABLE AND TURNTABLE CONTROL METHOD

(71) Applicant: Premium Audio Company Technology Center K.K., Osaka (JP)

(72) Inventor: Kairyo Yabashi, Osaka (JP)

(73) Assignee: Premium Audio Company Technology Center K.K., Osaka (JP)

(21) Appl. No.: 19/677,969

(22) Filed: May 14, 2026

(30) Foreign Application Priority Data
May 14, 2025 (JP) 2025-081254

(51) Int. Cl. G11B 3/60

(52) U.S. Cl. CPC G11B 3/60

(57) ABSTRACT

A leveling system for a turntable assembly includes a detection unit including an acceleration sensor that is configured to measure acceleration, a drive unit including an electric motor, and a control unit including a controller that is configured to execute a leveling routine to level the turntable assembly via at least the electric motor and based at least on the acceleration measured by the acceleration sensor.

### CROSS-REFERENCE TO RELATED APPLICATION

This application claims priority to Japanese Patent Application No. 2025-081254, filed May 14, 2025, entitled “TURNTABLE AND TURNTABLE CONTROL METHOD,” the entire disclosure of which is incorporated herein by reference.

### FIELD OF THE DISCLOSURE

The present invention relates to a turntable assembly, and specifically to a turntable assembly and a turntable control method for leveling the turntable assembly.

### SUMMARY OF THE DISCLOSURE

According to one aspect of the present disclosure, a turntable assembly includes a support frame configured to support a platter, a plurality of drive units operably coupled to the support frame, wherein each of the plurality of drive units is configured to at least partially adjust the height of the support frame, a detection unit configured to detect a tilt of the platter, and a control unit configured to adjust the plurality of drive units to level the platter.

According to another aspect of the present disclosure, a method of leveling a turntable includes providing a turntable assembly with a platter and a first adjustable leg, wherein the first adjustable leg includes an electric motor configured to adjust a height dimension of the first adjustable leg. The method further includes detecting a tilt of the platter, calculating a drive amount of the electric motor that corresponds to leveling the platter, and driving the electric motor according to the drive amount to at least partially level the platter.

According to yet another aspect of the present disclosure, a leveling system for a turntable assembly includes a detection unit including an acceleration sensor that is configured to measure acceleration, a drive unit including an electric motor, and a control unit including a controller that is configured to execute a leveling routine to level the turntable assembly via at least the electric motor and based at least on the acceleration measured by the acceleration sensor.

Ensuring that a turntable assembly is level, and not tilted, can yield an optimized sound quality and stabilization during the operation thereof. For example, reducing a tilt of the turntable assembly, relative to a horizontal axis, results in reduced stylus tracking errors during the operation of the turntable assembly, reduced changes in stylus pressure during the operation of the turntable assembly, and reduced changes in left-right audio balance during the operation of the turntable assembly. It is therefore an object of the present disclosure to provide a turntable assembly and a turntable control method configured to level the turntable assembly with high precision, regardless of the location of the center of gravity of the turntable assembly.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper side perspective view of a turntable assembly according to the present disclosure;

FIG. 2 is a lower side perspective exploded view of the turntable assembly according to the present disclosure;

FIG. 3 is a bottom plan view of the turntable assembly according to the present disclosure;

FIG. 4 is a bottom plan view of a platter support structure of the turntable assembly according to the present disclosure;

FIG. 5 is an upper side perspective exploded view of a detection unit of the turntable assembly according to the present disclosure;

FIG. 6 is an upper side perspective exploded view of a drive unit of the turntable assembly according to the present disclosure;

FIG. 7 is a side elevation cross-sectional view of the drive unit of the turntable assembly according to the present disclosure;

FIG. 8 is a block diagram illustrating a leveling system of the turntable assembly according to the present disclosure;

FIG. 9 is a partial front view and a partially enlarged front view of the turntable assembly according to the present disclosure;

FIG. 10 is a diagram illustrating an example of information displayed on a touch panel of the turntable assembly according to the present disclosure;

FIG. 11 is a diagram illustrating an example of information displayed on the touch panel of the turntable assembly according to the present disclosure;

FIG. 12 is a diagram illustrating an example of information displayed on the touch panel of the turntable assembly according to the present disclosure; and

FIG. 13 is a flowchart illustrating an exemplary turntable control method according to the present disclosure.

### DETAILED DESCRIPTION

The present illustrated embodiments reside primarily in combinations of method steps and apparatus components related to a turntable assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

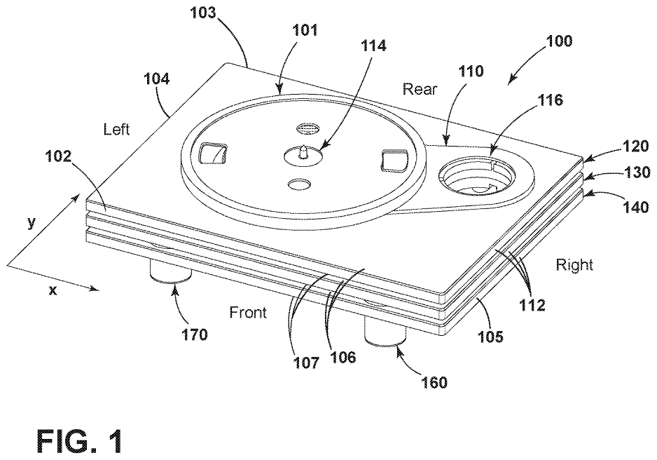

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to a surface of the device closest to an intended viewer, and the term “rear” shall refer to a surface of the device furthest from the intended viewer. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

An embodiment of the present disclosure will now be described with reference to the drawings. For clarity, like reference numerals are assigned to like components in each figure, and redundant descriptions of these components have been omitted.

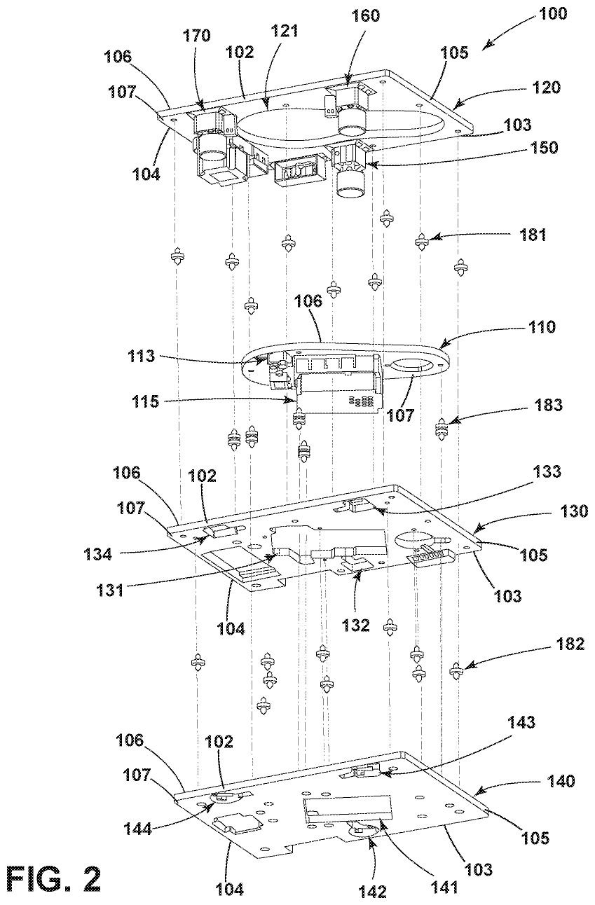

With reference to FIGS. 1 and 2, reference numeral 100 generally refers to a turntable assembly 100 (hereinafter “turntable”). According to various aspects, the turntable 100 includes a platter 101, a platter support structure 110, a support frame 112 including a first support body 120, a second support body 130, and a third support body 140, a first drive unit 150, a second drive unit 160, and a third drive unit 170. As illustrated, the support frame 112 has front and rear sides 102, 103 that extend between first and second laterally-spaced sides 104, 105. Here, each of the first, second, and third support bodies 120, 130, 140 partially defines the front and rear sides 102, 103 and the first and second laterally-spaced sides 104, 105. In the following description, on a horizontal plane, an axis parallel to the front and rear sides 102, 103 of the turntable 100, as shown, is defined as an X-axis, and an axis parallel to the first and second laterally spaced sides 104, 105 of the turntable 100, as shown, is defined as a Y-axis. Accordingly, the X-axis and the Y-axis are orthogonal to each other.

According to various implementations, the platter 101 of the turntable 100 has a predetermined weight and is configured to support a record on a top surface 106 thereof. The platter 101 is typically rotatably supported by the platter support structure 110. In some configurations, the platter 101 may have a disc shape. The platter support structure 110 and the platter 101 are typically intercoupled such that, with the support frame 112 being placed on a supportive surface, an angular offset or tilt of the platter 101 relative to the horizontal plane may be the same as a tilt of the platter support structure 110 relative to the horizontal plane.

As demonstrated in FIGS. 1 and 2, the first support body 120, the second support body 130, and the third support body 140 may be vertically arranged. Here, each of the platter support structure 110 and the first, second, and third support bodies 120, 120, 140 has a top surface 106, a bottom surface 107, and a predetermined thickness as measured between the top and bottom surfaces 106, 107 thereof. In an assembled condition of the turntable 100, the second support body 130 is in a spaced relationship with and vertically offset below the first support body 120, and the third support body 140 is in a spaced relationship with and vertically offset below the second support body 130. In some configurations, each of the first, second, and third support bodies 120, 120, 140 may be a plate with a rectangular profile. The first support body 120 has an aperture or through hole 121 extending from the top surface 106 thereof to the bottom surface 107 thereof, where the through hole 121 is configured to receive the platter support structure 110 in the assembled condition of the turntable 100. In some configurations, when viewed from above, the through hole 121 may substantially complement the profile of the platter support structure 110 and may be slightly larger than the platter support structure 110. As a result, the platter support structure 110 may be loosely fitted into the through hole 121 of the first support body 120.

According to various implementations, the second support body 130 and the first, second, and third drive units 150, 160, 170 may be mounted on or coupled to the bottom surface 107 of the first support body 120. As shown in FIG. 2, the first, second, and third drive units 150, 160, 170 are spaced from each other and partially surround the through hole 121 of the first support body 120. Here, the second and third drive units 160, 170 are situated proximate the front side 102 of the support frame 112, as defined by the first support body 120, and the first drive unit 150 is situated proximate the rear side 103 of the support frame 112, as defined by the first support body 120. The first drive unit 150 may be centered between the second and third drive units 160, 170 along the X-axis (FIG. 1).

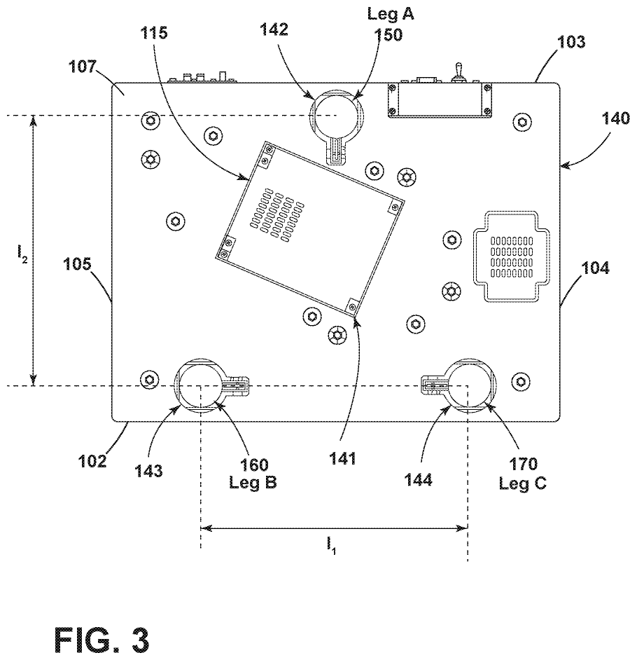

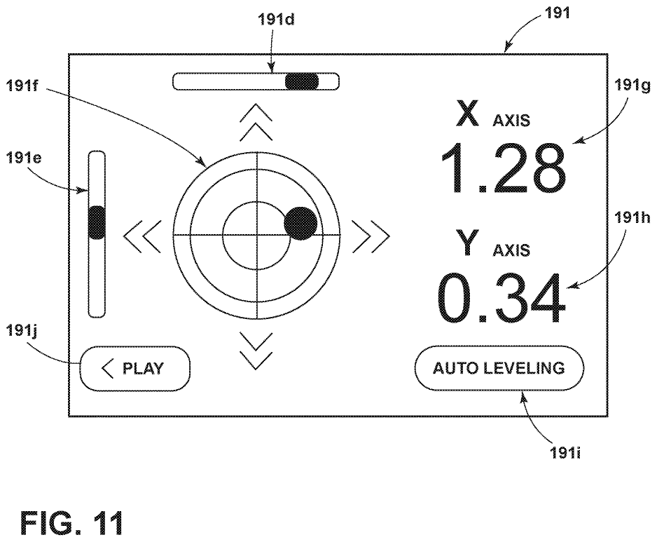

As exemplified in FIGS. 3, 11 is the distance between the axes of the second and third drive units 160, 170, and 12 is the distance between a straight line connecting the central axes of the second and third drive units 160, 170 and the central axis of the first drive unit 150. The first and second support bodies 120, 130 may be intercoupled via a plurality of bushings 181. As shown in FIG. 2, eight bushings 181 are disposed between the bottom surface 107 of the first support body 120 and the top surface 106 of the second support body 130, thereby maintaining a spaced relationship between the first and second support bodies 120, 130. According to various aspects, the plurality of bushings 181 may be made of a vibration-absorbing elastic material, for example.

As further demonstrated in FIGS. 1 and 2, the second support body 130 defines an upper cover through hole 131, a first upper motor through hole 132, a second upper motor through hole 133, and a third upper motor through hole 134. Here, each of the upper cover through hole 131, the first upper motor through hole 132, the second upper motor through hole 133, and the third upper motor through hole 134 extend through the second support body 130 from the top surface 106 thereof to the bottom surface 107 thereof. In the assembled condition of the turntable 100, the first, second, and third drive units 150, 160, 170 extend respectively through the first, second, and third upper motor through holes 132, 133, 134. Furthermore, a cover 115, which is coupled to the bottom surface 107 of the illustrated platter support structure 110 and described in more detail below, extends through the upper cover through hole 131 in the assembled condition of the turntable 100.

According to various implementations, the second and third support bodies 130, 140 are intercoupled via a plurality of bushings 182 (hereinafter “second bushings”). As shown in FIG. 2, ten second bushings 182 are disposed between the bottom surface 107 of the second support body 130 and the top surface 106 of the third support body 140, thereby maintaining a spaced relationship between the second and third support bodies 130, 140. According to various aspects, the plurality of second bushings 182 may be made of a vibration-absorbing elastic material, for example.

Further referring to FIG. 2, the third support body 140 defines a lower cover through hole 141, a first lower motor through hole 142, a second lower motor through hole 143, and a third lower motor through hole 144. In the assembled condition of the turntable 100, the first, second, and third drive units 150, 160, 170 extend respectively through the first, second, and third lower motor through holes 142, 143, 144 of the third support body 140. In some configurations, the platter support structure 110 may be coupled to the top surface 106 of the third support body 140 via a plurality of bushings 183 (hereinafter “third bushings”) that may be composed of a vibration-absorbing elastic material, such as rubber, and/or coil springs. According to one example, four third bushings 183 may be disposed between the bottom surface 107 of the platter support structure 110 and the top surface 106 of the third support body 140, thereby maintaining the platter support structure 110 and the third support body 140 in a spaced relationship.

In the assembled condition of the turntable 100, the first drive unit 150 may be loosely fitted into the first upper motor through hole 132 and the first lower motor through hole 142, the second drive unit 160 may be loosely fitted into the second upper motor through hole 133 and the second lower motor through hole 143, and the third drive unit 170 may be loosely fitted into the third upper motor through hole 134 and the third lower motor through hole 144. As shown in FIGS. 2, 3, and 9, a bottom portion of each of the first, second, and third drive units 150, 160, 170 protrudes downward from the bottom surface 107 of the third support body 140 and is configured to come into contact with an installation surface defined by a shelf of an audio rack, for example. Accordingly, the first, second, and third drive units 150, 160, 170 may form the legs of the turntable 100.

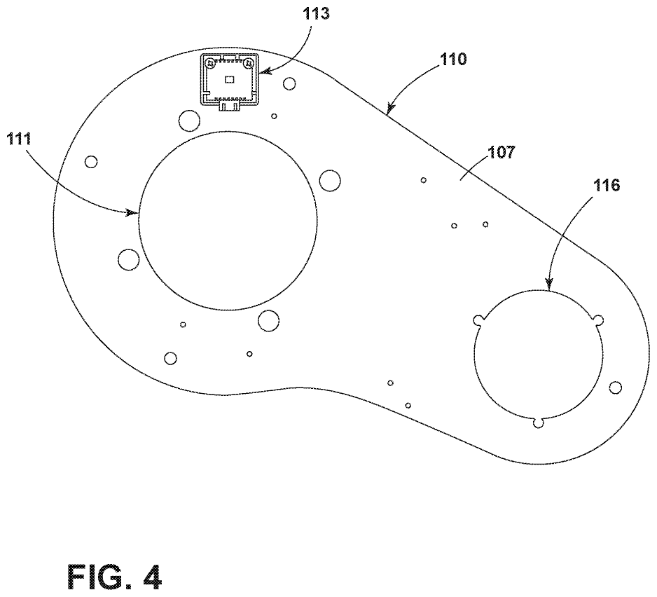

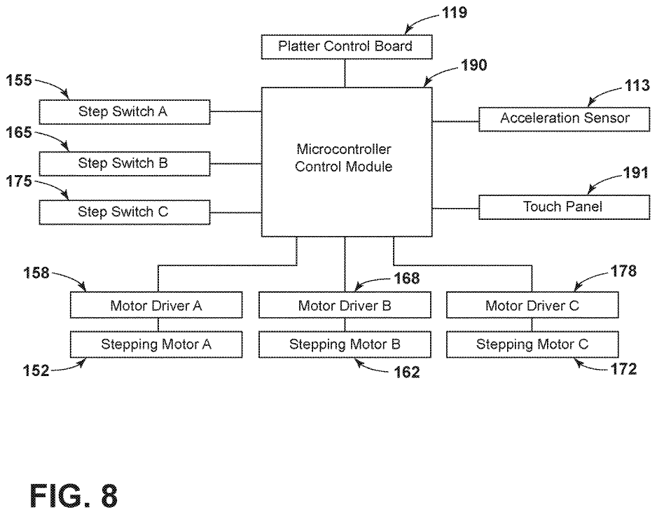

With reference to FIGS. 2 and 4, the platter support structure 110 may have a shape resembling two disks that are connected via straight and curved lines, and particularly a first disk and a second disk that may be smaller than the first disk. As illustrated, first and second through holes 111, 116 are respectively formed in the center of the first and second disks. The platter support structure 110 is equipped with a platter motor 114 (FIG. 1) and a platter control board 119 (FIG. 8), as well as an acceleration sensor 113 that forms at least a portion of a detection unit, as described in more detail below. The platter motor 114 is mounted in the first through hole 111 of the platter support structure 110 and supports the platter 101 so that the platter 101 can be rotated by the platter motor 114. The second through hole 116 defines an arm hole for holding a tonearm of the turntable 100. As shown in FIG. 2, a cover 115 may be attached to the bottom surface 107 of the platter support structure 110 and may house the platter motor 114 and the platter control board 119. In some configurations, the cover 115 is loosely fitted into the upper cover through hole 131 of the second support body 130 and the lower cover through hole 141 of the third support body 140.

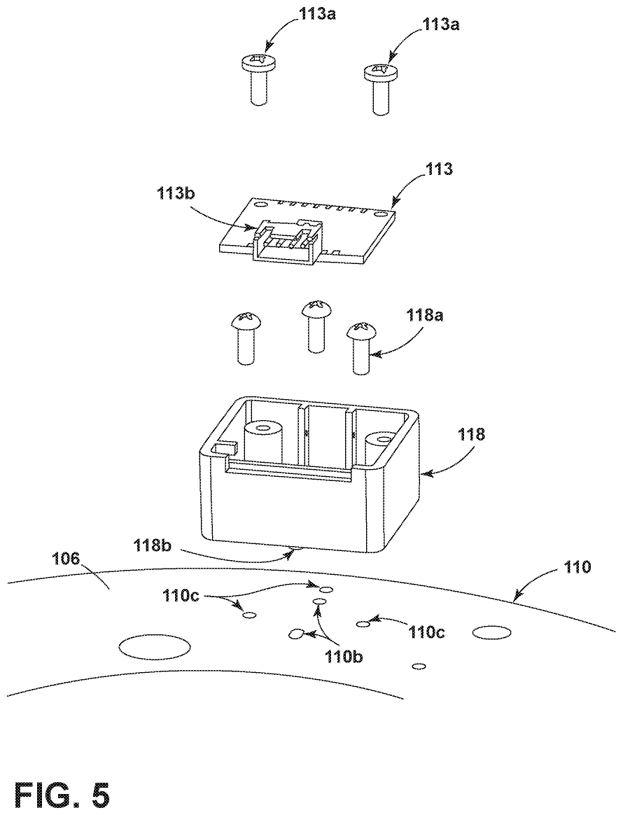

Referring to FIG. 5, the acceleration sensor 113 of the detection unit may be mounted on the bottom surface 107 of the platter support structure 110. According to one example, the acceleration sensor 113 may be mounted on a substrate that is capable of measuring and outputting acceleration in six axial directions 100 times per second. As illustrated, the acceleration sensor 113 is mounted inside a sensor housing 118 with a plurality of screws 113a and is electrically coupled to a microcontroller control module 190 via a connector 113b and electrical wiring (not shown). Here, the sensor housing 118 has a plurality of projections 118b protruding from a bottom surface 107 thereof, and the platter support structure 110 has a plurality of holes 110b that correspond to the plurality of projections 118b. Accordingly, the sensor housing 118 is mounted on the platter support structure 110, with each of the plurality of projections 118b engaging one of the plurality of holes 110b. The illustrated platter support structure 110 also includes a plurality of threaded holes 110c that are respectively engaged by a plurality of screws 118a to mount the sensor housing 118 on the platter support structure 110. With the acceleration sensor 113 mounted on the platter support structure 110, the X-axis and the Y-axis that are shown in FIG. 1 may be distinct or different relative to the six axial directions detected by the acceleration sensor 113. Therefore, with the acceleration sensor 113 mounted on the platter support structure 110, an X-axis error Ox and a Y-axis error Oy (i.e., offsets along the X-axis and the Y-axis) may be measured and stored by the microcontroller control module 190.

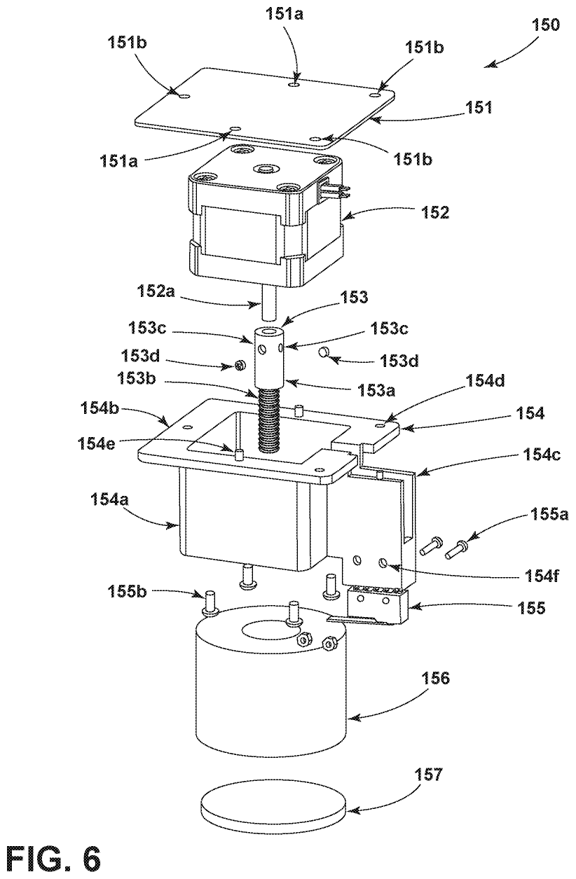

With reference to FIGS. 2, 6, and 7, the first, second, and third drive units 150, 160, 170 may have a substantially similar configuration relative to each other. Accordingly, for clarity, the first drive unit 150 will be primarily described in more detail below. For example, as demonstrated in FIG. 6, the first drive unit 150 includes a top cover 151, a stepper motor 152, a shaft holder 153, a motor housing 154, a stop switch 155, a bottom body 156, and a sole or pad 157. In some configurations, the top cover 151 may be a metal plate and may define two primary through holes 151a and three secondary through holes 151b, each of the two primary through holes 151a and the three secondary through holes 151b extending through the top cover 151 in a thickness direction thereof. The stepper motor 152 may have a 1.8-degree resolution or 200 steps per revolution, according to one non-limiting example. A rotatable motor shaft 152a of the stepper motor 152 may protrude away from the top cover 151. According to various aspects, the stepper motor 152 is electrically connected to the microcontroller control module 190.

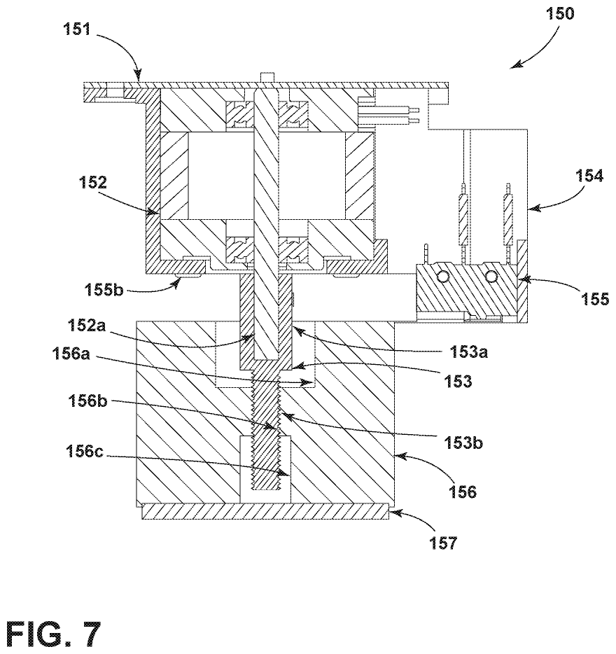

With regard to the first drive unit 150, the motor shaft 152a may be operably coupled to the shaft holder 153. As shown in FIGS. 6 and 7, the shaft holder 153 includes a cylindrical shaft receptacle 153a and a cylindrical male threaded portion 153b mounted to the shaft receptacle 153a and coaxial with the shaft receptacle 153a. Here, the shaft receptacle 153a defines a plurality of female threaded holes 153c that pass from an outer peripheral surface thereof to an inner peripheral surface thereof, and a set screw 153d is insertable into each of the female threaded holes 153c. With the motor shaft 152a being inserted into the shaft receptacle 153a of the illustrated shaft holder 153, the set screws 153d, at the tips thereof, engage the motor shaft 152a, thereby securing the motor shaft 152a to the shaft holder 153. The male threaded portion 153b of the shaft holder 153 may have an M6-size thread with a pitch of 1.0 mm, for example. Accordingly, during one full rotation of the motor shaft 152a of the stepper motor 152, the distance between the stepper motor 152 and the shaft holder 153 may change by about 1.0 mm, and the rotation of the motor shaft 152a by one step may result in a change in the distance between the stepper motor 152 and the shaft holder 153 by about 0.005 mm.

Referring still to FIGS. 6 and 7, the motor housing 154 of the first drive unit 150 is coupled to the stepper motor 152. Regarding the first drive unit 150, the motor housing 154 includes a main body 154a having a bottom surface and configured to house the stepper motor 152, a flange 154b projecting laterally from an upper end of the main body 154a around a peripheral surface of the main body 154a, and a switch holder 154c projecting laterally from a side of the main body 154a. As illustrated, the bottom surface of the main body 154a is provided with a shaft passage or through hole, through which the shaft holder 153 passes in an assembled condition of the first drive unit 150, and four fixing holes used to secure the stepper motor 152 to the bottom surface of the main body 154a. Here, male screws are respectively passable through the fixing holes to engage with female threads provided on a bottom surface of the stepper motor 152, thereby securing the stepper motor 152 to the motor housing 154.

Further regarding the first drive unit 150 illustrated in FIGS. 6 and 7, the flange 154b has two projections 154e protruding from a top surface thereof and three through holes 154d passing through the flange 154b in the thickness direction. As shown, the two projections 154e respectively engage the two primary through holes 151a in the top cover 151 in the assembled condition of the first drive unit 150. Screws (not shown) may be passed through the three through holes 154d, threaded into the three secondary through holes 151b in the top cover 151, and threaded into female threaded holes provided by the first support body 120, thereby securing the first drive unit 150 to the first support body 120.

The switch holder 154c of the first drive unit 150 illustrated in FIGS. 6 and 7 has two through holes 154f and securably intercouples with the stop switch 155 via screws 155a that pass through and engage the through holes 154f of the switch holder 154c. In some configurations, the stop switch 155 may be a microswitch. It is also contemplated that the stop switch 155 may include an actuator that may extend from a main body of the stop switch 155. In such configurations, in response to the actuator being pressed, the stop switch 155 turns on. The stop switch 155 is typically electrically connected to the microcontroller control module 190 via electrical wiring, for example (FIG. 8). With regard to the first drive unit 150, the actuator may be configured to come into contact with the top surface of the bottom body 156. According to various aspects, with the bottom body 156 being directly adjacent to or in close proximity to the motor housing 154, the actuator is pressed against the top surface of the bottom body 156, causing the stop switch 155 to turn on.

With further reference to FIGS. 6 and 7, the bottom body 156 may have a cylindrical shape and may define a cylindrical top-surface counterbore 156a provided on the top surface thereof, a threaded hole 156b with a female thread, and a cylindrical bottom-surface counterbore 156c provided on the bottom surface thereof. In some configurations, the top-surface counterbore 156a may have a larger diameter than the threaded hole 156b and the bottom-surface counterbore 156c, and the bottom-surface counterbore 156c may have a larger diameter than the threaded hole 156b. Here, the shaft receptacle 153a of the shaft holder 153 may be inserted into the top counterbore 156a with at least some give, and the male threaded portion 153b of the shaft holder 153 may thereafter be screwed into the threaded hole 156b. As a result, the tip of the male threaded portion 153b may extend into the bottom counterbore 156c. As illustrated, a thin, disc-shaped vibration-damping rubber pad 157, made of an elastic material (e.g., natural rubber), is coupled to the bottom surface of the bottom body 156 via an adhesive or similar material, for example. The diameter of the vibration-damping rubber pad 157 may be slightly smaller than the diameter of the bottom body 156 in some configurations.

According to various implementations, the shaft holder 153 rotates during rotation of the stepper motor 152. As a result, the stepper motor 152 moves up and down relative to the bottom body 156 with the turntable 100 being placed on the installation or mounting surface, and the first, second, and third support bodies 120, 130, 140, along with the platter support structure 110, move up and down. As demonstrated in FIG. 7, the first drive unit 150 is in a lowest position thereof, the stepper motor 152 and the shaft holder 153 are in close proximity to each other, and the stop switch 155 is turned on.

As demonstrated in FIGS. 2 and 3, the second and third drive units 160, 170 are spaced from each other and situated proximate the front side 102 of the support frame 112, the first drive unit 150 is situated proximate the rear side 103 of the support frame 112, and the first drive unit 150 is situated between the second and third drive units 160, 170 along the X-axis (FIG. 1). Accordingly, during movement of the first drive unit 150 up or down, or during movement of the second and third drive units 160, 170 up or down by the same amount relative to each other, a moment around the X-axis is generated in the turntable 100. For example, during movement of the first drive unit 150 up or down, the rear side 103 of the turntable 100 moves up or down, and during movement of the second and third drive units 160, 170 up or down by the same amount relative to each other, the front side 102 of the turntable 100 moves up or down.

With reference to FIGS. 1 and 8, the turntable 100 includes: a control unit composed at least partially of the microcontroller control module 190; the platter control board 119; a touch panel 191; a stepper motor A 152, a stop switch A 155, and a motor driver A 158 provided by the first drive unit 150; a stepper motor B 162, a stop switch B 165, and a motor driver B 168 provided by the second drive unit 160; and a stepper motor C 172, a stop switch C 175, and a motor driver C 178 provided by the third drive unit 170. The microcontroller control module 190 may include, for example, an FPGA, an ASIC, or a microcontroller. In some configurations, the microcontroller control module 190 may be mounted on a circuit board and fixedly coupled to the bottom surface 107 of the first support body 120 via the circuit board, for example. According to various aspects, the platter control board 119 operates based on signals from the microcontroller control module 190 and, based on the rotational speed of the platter 101 detected by a rotational sensor (not shown), may control the rotation of the platter motor 114 so that the rotational speed of the platter 101 reaches a predetermined value and remains constant.

According to various implementations, the acceleration sensor 113 is configured to measure acceleration data and transmit the acceleration data to the microcontroller control module 190. In some configurations, the acceleration data measured and transmitted to the microcontroller control module 190 by the acceleration sensor 113 may include acceleration values in six axial directions. In such configurations, the microcontroller control module 190 is configured to calculate the tilt of the platter support structure 110 based on the acceleration values in the six axial directions obtained from the acceleration sensor 113. As previously discussed, the tilt of the platter 101 may be substantially similar to the tilt of the platter support structure 110. Accordingly, the microcontroller control module 190 may be configured to calculate the tilt of the platter 101 based on the acceleration values in the six axial directions obtained from the acceleration sensor 113.

Based on the calculated tilt of the platter 101, the microcontroller control module 190 is configured to calculate a rotation amount of stepper motor A 152, stepper motor B 162, and stepper motor C 172 for leveling the turntable 100 and transmit signals based on the calculated rotation amounts to motor driver A 158, motor driver B 168, and motor driver C 178. In response to receiving these signals, motor driver A 158 is configured to transmit signals to stepper motor A 152, motor driver B 168 is configured to transmit signals to stepper motor B 162, and motor driver C 178 is configured to transmit signals to stepper motor C 172. As a result, stepper motor A 152 rotates by a predetermined angle (step) based on the signals from motor driver A 158, stepper motor B 162 rotates by a predetermined angle (step) based on the signals from motor driver B 168, and stepper motor C 172 rotates by a predetermined angle (step) based on the signals from motor driver C 178.

According to various turntable leveling methods, it may be desirable to first operate the first, second, and third drive units 150, 160, 170 to the lowest achievable height dimensions thereof. Accordingly, during an operation of stepper motor A 152 corresponding to lowering the first drive unit 150, the microcontroller control module 190 determines that stepper motor A 152 has reached its closest position to the bottom body 156 of the first drive unit 150 in response to stop switch A 155 being turned on, and the microcontroller control module 190 thereafter stops stepper motor A 152. During an operation of stepper motor B 162 corresponding to lowering the second drive unit 160, the microcontroller control module 190 determines that stepper motor B 162 has reached its closest position to the bottom body 156 of the second drive unit 160 in response to stop switch B 165 being turned on, and the microcontroller control module 190 thereafter stops stepper motor B 162. During an operation of stepper motor C 172 corresponding to lowering the third drive unit 170, the microcontroller control module 190 determines that stepper motor C 172 has reached its closest position to the bottom body 156 of the third drive unit 150 in response to stop switch C 175 being turned on, and the microcontroller control module 190 thereafter stops stepper motor C 172.

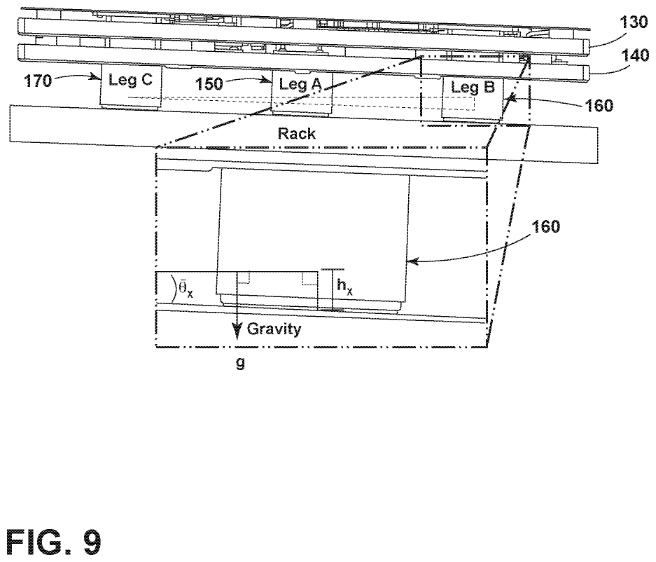

As illustrated in FIG. 9, the third drive unit 170 (leg B) is located below the second drive unit 160 (leg C) in the direction of gravity, that is, at a lower position. Here, the X-axis offset Ox and the Y-axis offset Oy of the turntable 100 or the platter 101 thereof, relative to the X-axis and the Y-axis (FIG. 1), respectively, may be measured and stored by the microcontroller control module 190. The acceleration sensor 113 may then measure acceleration in the six axial directions at a predetermined sample rate and transmit the measured acceleration data to the microcontroller control module 190. Based on the measured acceleration data, the microcontroller control module 190 may calculate an angle of tilt (“tilt angle”) of the turntable 100 relative to the X-axis and a tilt angle of the turntable 100 relative to the Y-axis for each sample of measured acceleration data. According to Equation 1, with the resulting calculated tilt angles, the microcontroller control module 190 may calculate the average of the resulting calculated tilt angles and add the X-axis offset Ox and the Y-axis offset Oy to this average. This produces an X-direction tilt angle θ̅ₓ and a Y-direction tilt angle θ̅_{y} that account for errors in the X-axis and Y-axis directions. For ease of understanding, θ̅ₓ and θ̅_{y} are rendered below as θx and θy.

X-Direction Tilt θ̅ₓ[rad]={−(θₓ₁+θₓ₂+ . . . θₓₙ)/n}+Oₓ

Y-Direction Tilt θ̅_{y}[rad]={(θ_{y1}+θ_{y2}+ . . . θ_{yn})/n}+O_{y} [Equation 1]

Prior to the leveling of the turntable 100 or the platter 101 thereof, the first, second, and third drive units 150, 160, 170 may be at or operated to the lowest positions thereof, that is, with stepper motors A, B, and C 152, 162, 172 and the shaft holders 153 respectively corresponding thereto may be closest to each other. Here, with the supportive or contact surface being tilted by the X-direction tilt angle θx relative to the horizontal plane (i.e., being rotated around the Y-axis to form the X-direction tilt angle θx with the X-axis), the platter 101 is also tilted by the X-direction tilt angle θx relative to the horizontal plane.

As illustrated in FIG. 9, leg B, that is, the center of the bottom surface of the second drive unit 160, is lower by a height hx relative to the horizontal plane, where hx=|I₁×tan(θx)|. Accordingly, hx represents a distance by which the center of the bottom surface of the second drive unit 160 is below the horizontal plane in the X-axis direction. In configurations where the distance between the stepper motor 162 and the corresponding shaft holder (not shown) is adjustable at 0.005 mm increments, the stepper motor 162 is rotated by Sx steps, where Sx=hx/0.005Sx steps, to extend the second drive unit 160 such that the X-direction tilt angle θx is brought toward or to zero. According to various aspects, the number of these steps (Sx) is the first horizontal drive amount. Rotating the stepper motor 162 by the first horizontal drive amount enables the platter 101 to be kept level even when the contact surface is tilted by θx relative to the horizontal plane. If the second drive unit 160 (leg C) is at a lower position than the third drive unit 170 (leg B), the stepper motor 172 is rotated by the first horizontal drive amount to adjust the height dimension of the third drive unit 170.

As explained above, when the second drive unit 160 or the third drive unit 170 is driven, the platter 101 rotates around the axis connecting the central axial directions of the first drive unit 150 and the second drive unit 160. Therefore, at first glance, it may appear that the tilt of the platter 101 in the X-axis direction cannot be fully corrected. However, since the amount of tilt in the platter 101 is generally small, it has been found that the tilt of the platter 101 can be corrected simply by driving the second drive unit 160 or the third drive unit 170.

According to various implementations, with the contact surface being tilted by the Y-direction tilt angle θy relative to the horizontal plane (i.e., being rotated around the X-axis to form the Y-direction tilt angle θy with the Y-axis), the platter 101 is also tilted by the Y-direction tilt angle θy relative to the horizontal plane. Here, the first drive unit 150 may be lower than the second drive unit 160 and the third drive unit 170, resulting in leg A, that is, the center of the bottom surface of the first drive unit 150, being lower than the horizontal plane by a height hy, where hy=|I₂×tanθy|. Accordingly, hy indicates the distance by which the center of the bottom surface of the first drive unit 150 is lower than the horizontal plane in the Y-axis direction. In configurations where the distance between the stepper motor 152 and the shaft holder 153 is adjustable at 0.005 mm increments, the stepper motor 152 is rotated by Sy steps, where Sy=hy/0.005, to extend the first drive unit 150 such that the Y-direction tilt angle θy is brought toward or to zero. The number of these steps (Sy) is the second horizontal drive amount. This enables the platter 101 to be kept level even when the contact surface is tilted by the Y-direction tilt angle θy relative to the horizontal plane. If the first drive unit 150 is higher than the second and third drive units 160, 170, the second horizontal drive amount Sy is calculated based on hy, which is determined according to the Y-direction tilt angle θy and the positions of each of the first, second, and third drive units 150, 160, 170. Thereafter, the second and third drive units 160, 170 are extended by the second horizontal drive amount Sy.

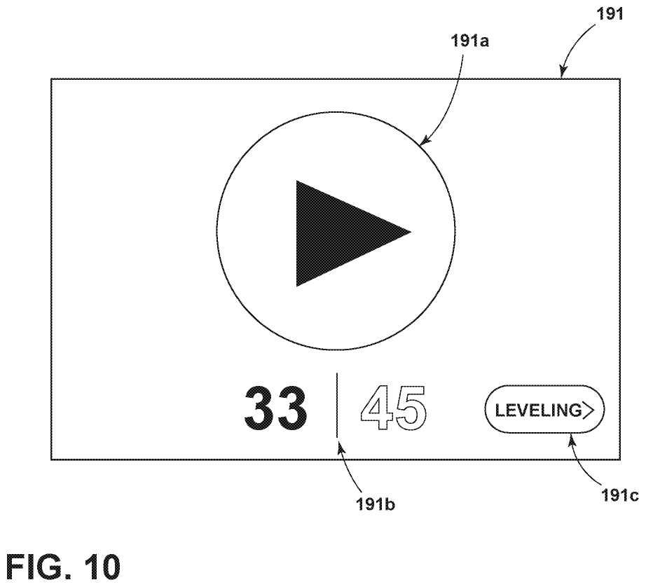

With reference to FIGS. 10-12, the turntable 100 may include the touch panel 191 that forms a display unit that may be installed on the front of the turntable 100, for example, and displays various types of information based on signals from the microcontroller control module 190. The information displayed by the touch panel 191 may include, for example, a status corresponding to whether the platter 101 is rotating, the rotational speed of the platter 101, and the tilt of the platter 101.

FIG. 10 shows an example of information displayed on the touch panel 191 with the platter 101 at a standstill and a rotation speed of the platter 101 set to 33 rpm. As illustrated, the touch panel 191 displays a start button 191a, a rotation speed button 191b, and a leveling control button 191c. The start button 191a is displayed as a circle with a triangle inside the circle, the rotation speed button 191b is displayed so that the user can select either 33 rpm or 45 rpm, and the leveling control button 191c is displayed as a selectable button in the lower right corner of the touch panel 191. In response to the user touching the start button 191a, the touch panel 191 may send a signal indicating that the start button 191a has been touched to the microcontroller control module 190. The microcontroller control module 190 may rotate the platter 101 in response to receiving the signal indicating that the start button 191a has been touched.

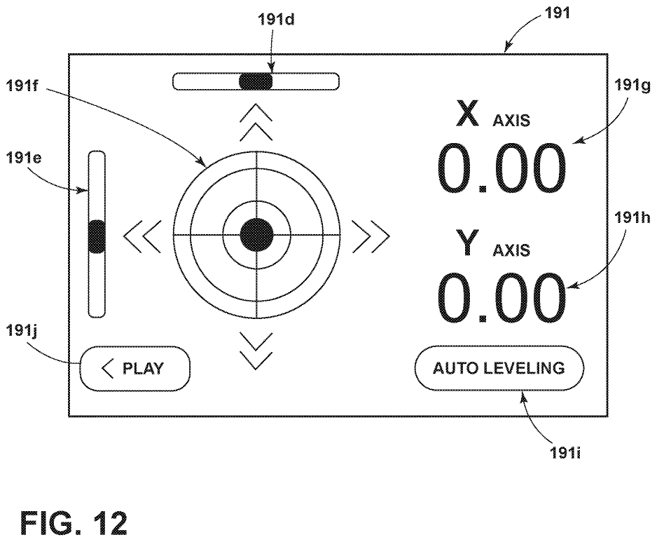

FIG. 11 shows an example of information displayed on the touch panel 191 in response to the user touching the leveling control button 191c. As illustrated, the touch panel 191 displays a state in which the platter 101 is tilted. The touch panel 191 displays the X-axis position 191d, the Y-axis position 191e, the horizontal position 191f, the X-axis tilt angle 191g, the Y-axis tilt angle 191h, the leveling control button 191i, and a play button 191j. In some configurations, the touch panel 191 may display the exemplary information illustrated in FIG. 10 in response to a user touching the play button 191j. Furthermore, the touch panel 191 may display the exemplary information illustrated in FIG. 12 in response to a user touching the leveling control button 191i.

In some configurations, the X-axis position 191d may be represented via a bubble tube graphic in which a point or marker displayed within a substantially rectangular frame indicates the tilt of the platter 101 in the X-axis direction (θx). The Y-axis position 191e may be represented via a bubble tube in which a point or marker displayed within a substantially rectangular frame indicates the tilt of the platter 101 in the Y-axis direction (θy). The horizontal position 191f may be modeled after a bubble tube in which a point or marker is displayed inside concentric circles, indicating the tilt of the platter 101 relative to the X-axis and Y-axis directions. As demonstrated in FIG. 11, the X-axis tilt angle 191g indicates the X-direction tilt angle θx of the platter 101, and the Y-axis tilt angle 191h indicates the Y-direction tilt angle θy of the platter 101. The microcontroller control module 190 may calculate the positions and tilt angles of each marker based on acceleration values from the acceleration sensor 113 and may display them on the touch panel 191. In response to the leveling control button 191i being engaged or touched by a user, the microcontroller control module 190 may execute automatic leveling control processing described below to adjust the platter 101 to a horizontal position.

FIG. 12 shows an example of information displayed on the touch panel 191 after the automatic leveling control processing has been executed. As illustrated, the platter 101 is in a level state, and the marker of each of the X-axis position 191d, the Y-axis position 191e, and the horizontal-direction position 191f is centered. In other words, after the automatic leveling control processing has been completed, the microcontroller control module 190 recalculates the position and tilt angle of each marker based on acceleration values from the acceleration sensor 113 and updates the markers displayed on the touch panel 191. Here, the automatic leveling control processing confirms that the platter 101 is level.

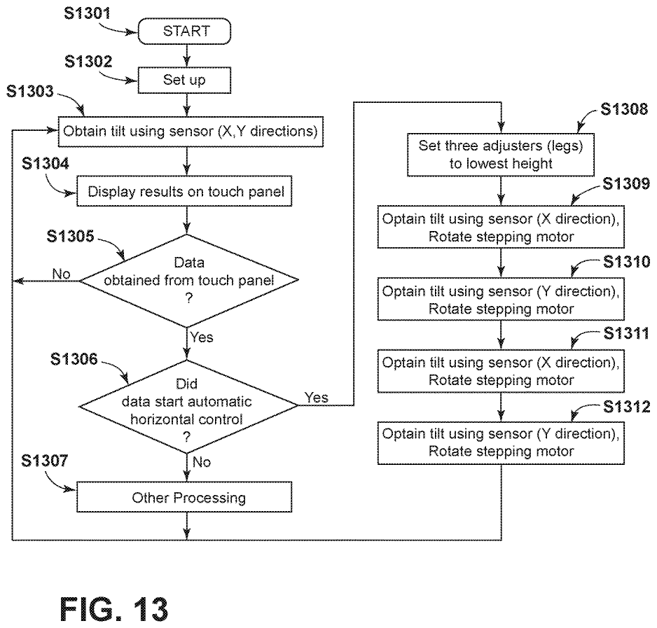

With reference to FIG. 13, the automatic leveling control processing is executed primarily by the microcontroller control module 190. First, when power is supplied to the turntable 100, the microcontroller control module 190 initiates the automatic leveling control processing in step S1301. In step S1302, the microcontroller control module 190 initializes each component and activates, inter alia, the acceleration sensor 113, stepper motor A 152, stepper motor B 162, and stepper motor C 172.

In step S1303, the microcontroller control module 190 receives acceleration data from the acceleration sensor 113 and calculates the tilt angles relative to the X-axis and Y-axis. Then, based on the calculated tilt angles, the average value of fifty consecutively obtained tilt angles, for example, is calculated, and the X-axis offset Ox and the Y-axis offset Oy are added to this average value. As a result, tilt angles are produced that account for errors in the X-axis and Y-axis directions.

In step S1304, the microcontroller control module 190 is configured to prompt the touch panel 191 to display the tilt angles that account for the errors in the X-axis and Y-axis directions. In step S1305, the microcontroller control module 190 determines whether any input has been received from the touch panel 191. In some configurations, in response to a user touching the start button 191a, the rotation speed button 191b, or the leveling control button 191c, the processing proceeds to step $1306. If no input has been received, the processing may return to step S1303. In step S1306, the microcontroller control module 190 determines whether the input received from the touch panel 191 is input that initiates the automatic leveling control processing. In other words, the microcontroller control module 190 determines whether the leveling control button 191c has been touched. In response to a determination that the leveling control button 191c has been touched, the processing proceeds to step S1308, and the automatic leveling control processing is executed. Steps S1308 to S1312 constitute one example of the automatic leveling control processing. In response to a determination that the leveling control button 191c has not been touched, the processing proceeds to step S1307, and after executing other processing, that is, processing corresponding to touching of the start button 191a or the rotation speed button 191b, for example, the processing returns to step S1303.

In step S1308, the first, second, and third drive units 150, 160, 170 are lowered to their lowest positions. In other words, stepper motor A 152, stepper motor B 162, and stepper motor C 172 are rotated until stop switch A 155, stop switch B 165, and stop switch C 175 have been turned on, indicating that the stepper motors 152, 162, 172 and the corresponding shaft holders are as close to each other as possible.

In step S1309, the acceleration sensor 113 measures acceleration and transmits it to the microcontroller control module 190. The microcontroller control module 190 receives the acceleration data from the acceleration sensor 113 and calculates the tilt angle relative to the X-axis. Then, based on the calculated tilt angle, the average value of fifty consecutively obtained tilt angles, for example, is calculated, and the X-axis offset Ox is added to this value. In this way, the microcontroller control module 190 obtains a tilt angle that takes into account the error in the X-axis direction. This processing constitutes at least a portion of the detection step. Then, based on this tilt angle, the number of steps (i.e., the drive amount) the stepper motors are to be moved is calculated, and signals are sent to the motor drivers based on this calculated number of steps. This processing constitutes at least a portion of the control step. The motor drivers operate the stepper motors based on the received signals. This processing constitutes at least a portion of the drive step. As a result of this processing, a tilt relative to the X-axis is correctable.

In step S1310, the microcontroller control module 190 receives acceleration data from the acceleration sensor 113 and calculates the tilt angle relative to the Y-axis. Then, based on this calculated tilt angle, the microcontroller control module 190 calculates the average value of fifty consecutively obtained tilt angles, for example, and adds the Y-axis offset Oy to this value. As a result, the microcontroller control module 190 calculates a tilt angle taking into account the error in the Y-axis direction. This processing constitutes at least a portion of the detection step. Then, based on this tilt angle, the number of steps (i.e., the drive amount) the stepper motors are to be moved is calculated, and signals are sent to the motor drivers based on this number of steps. This processing constitutes at least a portion of the control step. The motor drivers operate the stepper motor based on the received signal. This processing constitutes at least a portion of the drive step. As a result of this processing, a tilt relative to the Y-axis is correctable.

In step S1311, processing similar to that in step S1309 is performed. Specifically, the microcontroller control module 190 receives acceleration data from the acceleration sensor 113 and calculates the tilt angle relative to the X-axis. Then, based on the calculated tilt angle, the average of fifty consecutively obtained tilt angles, for example, is calculated, and the X-axis offset Ox is added to this value. As a result, the microcontroller control module 190 obtains a tilt angle that accounts for the error in the X-axis direction. This processing constitutes at least a portion of the detection step. Then, based on this tilt angle, the number of steps (i.e., the drive amount) the stepper motors are to be moved is calculated, and signals are then sent to the motor drivers based on this number of steps. This processing constitutes at least a portion of the control step. The motor drivers operate the stepper motors based on the received signals. This processing comprises at least a portion of the drive step. As a result of this processing, a tilt relative to the X-axis is correctable.

In step S1312, processing similar to that in step S1310 is performed. Specifically, the microcontroller control module 190 receives acceleration data from the acceleration sensor 113 and calculates the tilt angle relative to the Y-axis. Then, from the calculated tilt angle, the average of fifty consecutively obtained tilt angles, for example, is calculated, and the Y-axis offset Oy is added to this value. As a result, the microcontroller control module 190 calculates the tilt angle taking into account the error in the Y-axis direction. This processing constitutes at least a portion of the detection step. Then, based on this tilt angle, the number of steps (i.e., the drive amount) the stepper motors are to be moved is calculated, and signals are sent to the motor drivers based on this number of steps. This processing comprises at least a portion of the control step. The motor drivers operate the stepper motors based on the received signals. This processing constitutes at least a portion of the drive step. As a result of this processing, a tilt relative to the Y-axis is correctable.

After steps S1311 and S1312, the microcontroller control module 190 returns to the processing in step S1303. The automatic leveling control processing in the present embodiment may effectively repeat the same operations performed in steps S1309 and S1310 again in steps S1311 and S1312. In other words, the leveling of the platter 101 is checked twice during a single iteration of the automatic leveling control processing, according to one non-limiting example. This ensures that the platter 101 has been leveled reliably, improving the stability of the processing. In the turntable and turntable control method of the present embodiment, since the first drive unit 150, the second drive unit 160, and the third drive unit 170 extend and retract to ensure the levelness of the platter 101, levelness can be maintained regardless of the location of a center of gravity of the turntable 100.

According to various implementations, the acceleration sensor 113 measures acceleration in six axial directions 100 times per second, for example. Here, the acceleration sensor 113 may take the average value of ten tilt values calculated from ten consecutively measured acceleration values, resulting in a horizontal accuracy for the platter 101 that is less than ±0.1 degrees. The horizontal accuracy can be improved by increasing the frequency at which the acceleration sensor 113 measures acceleration. For example, by measuring acceleration 500 times per second, taking the average of the fifty tilt values calculated from fifty acceleration values, and leveling the platter 101 using the tilt angle(s) calculated as described above, the horizontal accuracy can reach ±0.02 degrees.

Generally, a turntable 100 is structured to capture the undulations engraved in the grooves of a record with a record stylus and convert them into audio signals. In order for the record stylus to accurately detect the undulations engraved in the record grooves, the record stylus must make precise contact with the grooves. In order to achieve this, the record, and the platter on which the record has been placed, must be installed horizontally. In other words, for audiophiles seeking high-fidelity playback, ensuring the platter is level is of the utmost importance. In addition, slight changes in the installation environment (such as warping of the supporting floor or rack, changes in ground conditions, or aging of the components on which the turntable 100 is mounted) can cause the turntable 100 to no longer be level over time. For these reasons, in order to achieve high-fidelity playback, the turntable 100 must always be level relative to the direction of gravity. Conventional turntables employ a configuration in which the user manually rotates the turntable legs to extend or retract them and level the platter. However, this manual adjustment method is cumbersome, may detract from the listening experience, and may present a high barrier to entry for general users. However, in the present disclosure, the platter 101 can be easily and quickly leveled without manual labor simply by operating the touch panel 191, for instance. This ensures that the music experience is not compromised.

In the present embodiment, the second drive unit 160 or the third drive unit 170 was driven to correct the tilt of the platter 101 in the X-axis direction. However, the first drive unit 150 may also be driven in addition to the second drive unit 160 or the third drive unit 170 to correct the tilt of the platter 101 in the X-axis direction. The first horizontal drive amount is calculated based on hx, which is determined according to the tilt angle θx and the position of the first drive unit 150, and the first drive unit 150 is extended by the first horizontal drive amount. This enables the platter 101 to be leveled even when the contact surface is tilted by θx relative to the horizontal plane. Note that steps S1311 and S1312 do not have to be executed in the automatic leveling control process. Steps S1309 and S1310 ensure that the platter 101 is level.

Note that in the present embodiment, the tilt of platter 101 was explained using drop distances hx=|I₁×tanθx| and hy=|I₂×tanθy|. However, the drop distances may also be expressed as hx=|I₁×θx| and hy=|I₂×Oy| (where θx and θy are in radians). Because θx and θy are small in the anticipated operating environment of the turntable 100, this can be approximated as shown in Equation 2.

|I₁×sin θ̅ₓ|<=|I₁×θ̅ₓ|<=|I₁×tan θ̅ₓ| [Equation 2]

Although it was explained above that the microcontroller control module 190 calculates the average tilt, it is also possible to calculate the average acceleration value, derive a provisional tilt angle based on this average, and then add the offsets Ox and Oy to obtain tilt angles θx and θy. This has the same effect as averaging the tilt values. The number of drive units is not limited to three drive units, that is, the first drive unit 150, the second drive unit 160, and the third drive unit 170, and any number of drive units may be used. In the automatic leveling control processing, the first drive unit 150, the second drive unit 160, and the third drive unit 170 do not have to be lowered to the lowest positions thereof as in step S1308. Leveling may be performed based on the height dimensions of the first drive unit 150, the second drive unit 160, and the third drive unit 170 prior to executing the processing.

In the present disclosure, the user can ensure that platter 101 is level without having to manually rotate the legs of the turntable 100. Because the platter 101 can be leveled with high precision, changes in record stylus pressure, tracking errors, and left-right balance caused by the tilt of the platter 101 can be minimized, thus stabilizing and improving sound quality.

The sizes, shapes, and quantities of components shown in the specification and the drawings are for illustrative purposes only and do not limit the invention in any way. The materials used for the various components are also for illustrative purposes and do not limit the invention in any way.

Although embodiments of the present invention have been described with reference to the accompanying drawings, it will be apparent to those skilled in the art that modifications may be made to the structures of and relationships between the various components without departing from the scope and spirit of the invention as described herein.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure the term “coupled” (in all its forms, couple, coupling, coupled, etc.) generally means the joining of two components (electrical or mechanical) directly or indirectly to one another. Such joining may be stationary in nature or movable in nature. Such joining may achieved with the two components (electrical or mechanical) and any additional intermediate members being integrally formed as a single unitary body with one another or with two components. Such joining may be permanent in nature or may be removeable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

1-13. (canceled)

14. A turntable assembly, comprising:
a support frame configured to support a platter;
a plurality of drive units operably coupled to the support frame, wherein each of the plurality of drive units is configured to at least partially adjust the height of the support frame;
a detection unit configured to detect a tilt of the platter; and
a control unit configured to adjust the plurality of drive units to level the platter.

15. The turntable assembly of claim 14, wherein the plurality of drive units define legs of the turntable assembly, and wherein the plurality of drive units are configured to support the support frame above a surface.

16. The turntable assembly of claim 15, wherein each of the plurality of drive units includes a stepper motor, and wherein the stepper motors of the plurality of drive units are configured to incrementally adjust height dimensions of the plurality of drive units, respectively.

17. The turntable assembly of claim 14, wherein the plurality of drive units include a first drive unit, a second drive unit spaced from the first drive unit, and a third drive unit spaced from each of the first drive unit and the second drive unit, and wherein the first drive unit, the second drive unit, and the third drive unit are configured to at least partially surround the platter.

18. The turntable assembly of claim 17, wherein the support frame has a first side, an opposing second side, and a pair of laterally spaced sides extending between the first side and the second side, wherein the first drive unit is positioned proximate the second side, and wherein the second drive unit and the third drive unit are positioned proximate the first side.

19. The turntable assembly of claim 14, wherein the support frame includes a plurality of vertically stacked support bodies, the plurality of vertically stacked support bodies including:
a first support body;
a second support body vertically offset below the first support body and coupled to the first support body via a plurality of bushings; and
a third support body vertically offset below the second support body and coupled to the second support body via a plurality of bushings.

20. The turntable assembly of claim 19, wherein the plurality of drive units are coupled to a bottom surface of the first support body, and wherein each of the plurality of drive units extends through an aperture defined by the second support body and an aperture defined by the third support body.

21. The turntable assembly of claim 20, further comprising:
a platter support structure coupled to the second support body via a plurality of bushings, wherein the first support body defines an aperture at least partially surrounding the platter support structure.

22. The turntable assembly of claim 14, wherein the detection unit includes an acceleration sensor configured to measure acceleration in six axial directions, and wherein the control unit is configured to calculate the tilt of the platter based on the acceleration measured in the six axial directions by the acceleration sensor.

23. The turntable assembly of claim 14, further comprising:
a touch panel configured to display information corresponding to the tilt of the platter, wherein the control unit is configured to execute an automatic leveling control routine in response to a user input at the touch panel.

24. A method of leveling a turntable, comprising:
providing a turntable assembly with a platter and a first adjustable leg, wherein the first adjustable leg includes an electric motor configured to adjust a height dimension of the first adjustable leg;
detecting a tilt of the platter;
calculating a drive amount of the electric motor that corresponds to leveling the platter; and
driving the electric motor according to the drive amount to at least partially level the platter.

25. The method of claim 24, wherein the turntable assembly includes a second adjustable leg with a second electric motor and a third adjustable leg with a third electric motor.

26. The method of claim 25, further comprising:
calculating a second drive amount of the second electric motor that corresponds to leveling the platter;
driving the second electric motor according to the second drive amount to at least partially level the platter;
calculating a third drive amount of the third electric motor that corresponds to leveling the platter; and
driving the third electric motor according to the third drive amount to at least partially level the platter.

27. The method of claim 24, wherein calculating the drive amount of the electric motor that corresponds to leveling the platter includes calculating a first horizontal drive amount around a first axis and a second horizontal drive amount around a second axis that is orthogonal to the first axis.

28. The method of claim 27, wherein driving the electric motor according to the drive amount to at least partially level the platter includes at least one of:
driving the electric motor according to the first horizontal drive amount around the first axis; and
driving the electric motor according to the second horizontal drive amount around the second axis.

29. A leveling system for a turntable assembly, the leveling system comprising:
a detection unit including an acceleration sensor that is configured to measure acceleration;
a drive unit including an electric motor; and
a control unit including a controller that is configured to execute a leveling routine to level the turntable assembly via at least the electric motor and based at least on the acceleration measured by the acceleration sensor.

30. The leveling system of claim 29, wherein the controller, during the leveling routine, is configured to execute an action loop, in which the controller is configured to:
calculate a tilt of a turntable platter, relative to a horizontal plane, based on the acceleration measured by the acceleration sensor;
calculate a drive amount of the electric motor, based on the calculated tilt of the turntable platter, that corresponds to leveling the turntable platter; and
activate the electric motor to operate according to the drive amount to at least partially level the turntable platter.

31. The leveling system of claim 29, further comprising:
a touch panel configured to display a calculated tilt of a turntable platter.

32. The leveling system of claim 31, wherein the touch panel is further configured to:
receive a user input corresponding to the execution of the leveling routine; and
send a signal to the controller to prompt the controller to execute the leveling routine in response to receiving the user input.

33. The leveling system of claim 31, wherein the touch panel is configured to display the calculated tilt of the turntable platter in the form of an angle about a first axis and an angle about a second axis that is orthogonal relative to the first axis.
